(19) United States
(12) Patent Application Publication
(10) Pub. No.: US 2014/0211244 A1
(43) Pub. Date: Jul. 31, 2014

(54) PLUG-IN DISTRIBUTION SYSTEM, IMAGE PROCESSING APPARATUS, PLUG-IN DISTRIBUTION CONTROL METHOD

(71) Applicant: FUJI XEROX CO., LTD., Tokyo (JP)

(72) Inventor: Takashi MURAKAMI, Kanagawa (JP)

(73) Assignee: FUJI XEROX CO., LTD., Tokyo (JP)

(21) Appl. No.: 13/973,563

(22) Filed: Aug. 22, 2013

(30) Foreign Application Priority Data
Jan. 25, 2013 (JP) 2013-012263

(51) Int. Cl. G06F 3/12

(52) U.S. Cl. CPC G06F 3/1225
USPC 358/1.15

(57) ABSTRACT

A plug-in distribution system includes a distribution server and an image processing apparatus. The distribution server distributes a plug-in. The image processing apparatus is connected to the distribution server via a network and receives a plug-in from the distribution server and uses the received plug-in. In response to a request to distribute a plug-in from the image processing apparatus, the distribution server sets a function for the requested plug-in in accordance with function setting information which is set for each plug-in and for each distribution destination, and distributes the plug-in to the image processing apparatus.

### CROSS-REFERENCE TO RELATED APPLICATIONS

This application is based on and claims priority under 35 USC 119 from Japanese Patent Application No. 2013-012263 filed Jan. 25, 2013.

### BACKGROUND

(i) Technical Field

The present invention relates to a plug-in distribution system, an image processing apparatus, and a plug-in distribution control method.

(ii) Related Art

In a system in which single or plural multifunction devices and a server are connected to a network, it may be possible to distribute plug-ins used for extending features of the multifunction devices from the server to the multifunction devices. In this case, it is desirable to manage the use of plug-ins in an appropriate manner.

### SUMMARY

According to an aspect of the invention, there is provided a plug-in distribution system including a distribution server and an image processing apparatus. The distribution server distributes a plug-in. The image processing apparatus is connected to the distribution server via a network and receives a plug-in from the distribution server and uses the received plug-in. In response to a request to distribute a plug-in from the image processing apparatus, the distribution server sets a function for the requested plug-in in accordance with function setting information which is set for each plug-in and for each distribution destination, and distributes the plug-in to the image processing apparatus.

### BRIEF DESCRIPTION OF THE DRAWINGS

An exemplary embodiment of the present invention will be described in detail based on the following figures, wherein:

FIG. 1 is a block diagram of a system of an exemplary embodiment;

FIG. 2 is a block diagram of the configuration of a multifunction device of an exemplary embodiment;

FIG. 3 illustrates an operation for distributing a plug-in from a distribution server to a multifunction device;

FIG. 4 illustrates plug-in function setting information stored in a distribution server;

FIG. 5 is a flowchart of processing executed in an exemplary embodiment; and

FIG. 6 is a flowchart of processing executed in an exemplary embodiment; and

FIG. 7 illustrates plug-in function setting information stored in a distribution server.

### DETAILED DESCRIPTION

An exemplary embodiment of the present invention will be described below with reference to the drawings. The term “plug-in” discussed in this exemplary embodiment refers to a program which is executed in cooperation with a certain program in order to extend a feature of this certain program.

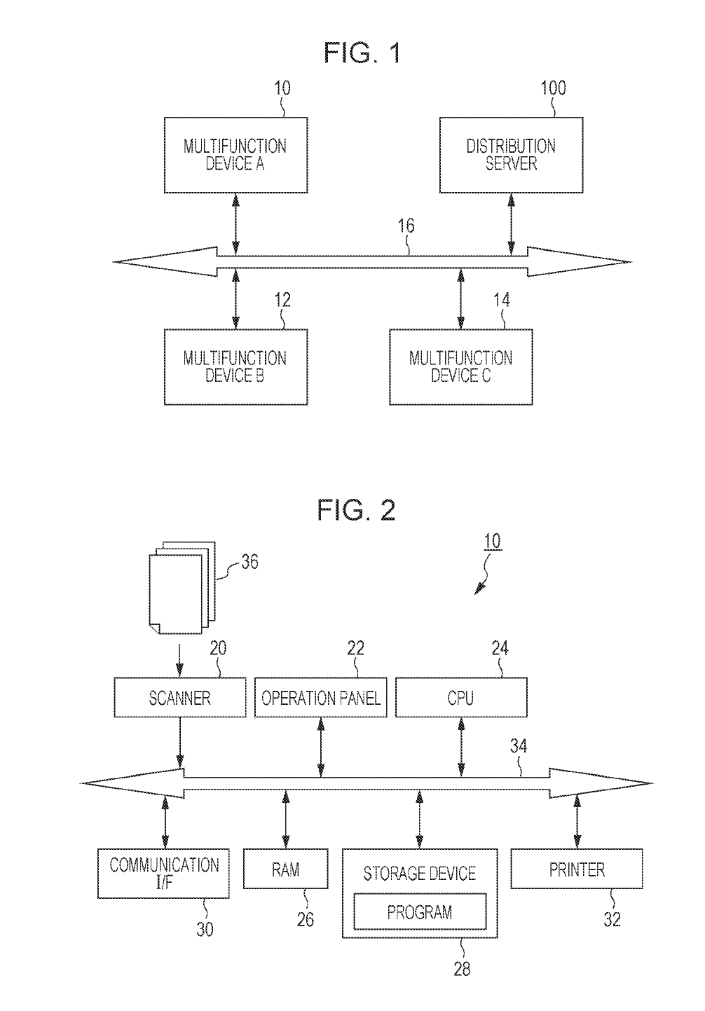

FIG. 1 is a block diagram of a system of this exemplary embodiment. A multifunction device 10, which serves as an image processing apparatus, is connected to a distribution server 100 via a network 16, such as the Internet. The distribution server 100 may be a server which provides so-called cloud services. The term “cloud” in this exemplary embodiment refers to a computer group which exists on the Internet, in particular, a server computer on the Internet. In addition to the multifunction device 10, there are other multifunction devices 12 and 14, which are also connected to the distribution server 100 via the network 16. For the sake of distinguishing the multifunction devices 10, 12, and 14 from each other, the multifunction devices 10, 12, and 14 are shown as a multifunction device A, a multifunction device B, and a multifunction device C, respectively, in FIG. 1.

In FIG. 1, all of the multifunction devices 10, 12, and 14 are connected to the distribution server 100 via the network 16. However, only the multifunction device 10 may be connected to the distribution server 100, and the multifunction devices 12 and 14 may be connected to the multifunction device 10 via a network different from the network 16, for example, a local area network (LAN).

The multifunction device 10 has various basic functions (features), such as a function of scanning documents, a function of transferring image data obtained by scanning documents to the distribution server 100 via the network 16, a function of downloading image data from the distribution server 100, and a function of viewing/printing image data. The multifunction device 10 also has a function of requesting the distribution server 100 to distribute a plug-in for extending a function (feature) of the multifunction device 10, a function of downloading a plug-in returned from the distribution server 100 in response to a request made by the multifunction device 10, a function of installing and using a downloaded plug-in, and a function of transferring a downloaded plug-in to the multifunction device 12 or 14 if necessary. The other multifunction devices 12 and 14 have functions similar to those of the multifunction device 10.

FIG. 2 is a block diagram of the configuration of the multifunction device 10. The multifunction device 10 includes a scanner 20, an operation panel 22, a central processing unit (CPU) 24, a random access memory (RAM) 26, a storage device 28, a communication interface (I/F) 30, a printer 32, and a bus 34. The multifunction device 10, which includes the CPU 24, the RAM 26, and the storage device 28, implements the above-described various basic functions by reading and executing a program and necessary plug-ins stored in the storage device 28. Accordingly, the multifunction device 10 may be considered as a computer, in particular, a client computer.

The scanner 20 scans a document 36 and forms an image of the document 36 into image data, and stores the image data in the RAM 26. The format of the image data is not particularly restricted, and may be, for example, Portable Document Format (PDF).

The operation panel 22 sets various parameters used when a user scans the document 36 by using the scanner 20. The operation panel 22 also sets various settings used when a user transfers (uploads) image data obtained by scanning the document 36 to the distribution server 100 and sets various settings used when a user views/prints a document stored in the distribution server 100. The operation panel 22 also sets various settings used when a user requests the distribution server 100 to distribute a required plug-in or when a user transfers a plug-in to the multifunction device 12 or 14.

The storage device 28 stores a processing program and plug-ins downloaded from the distribution server 100, and also stores various items of image data downloaded from the distribution server 100.

The CPU 24 reads and executes the processing program and plug-ins stored in the storage device 28 so as to control operations of the elements of the multifunction device 10 in accordance with the processing program and the plug-ins. More specifically, the CPU 24 transfers image data to the distribution server 100 via the communication I/F 30 in accordance with a request set by the operation panel 22. The CPU 24 also downloads image data stored in the distribution server 100 in response to a request set by the operation panel 22, and displays the downloaded image data on the operation panel 22, thereby allowing a user to view the image data. At the same time, the CPU 24 outputs the downloaded image data to the printer 32 and causes the printer 32 to print the image data.

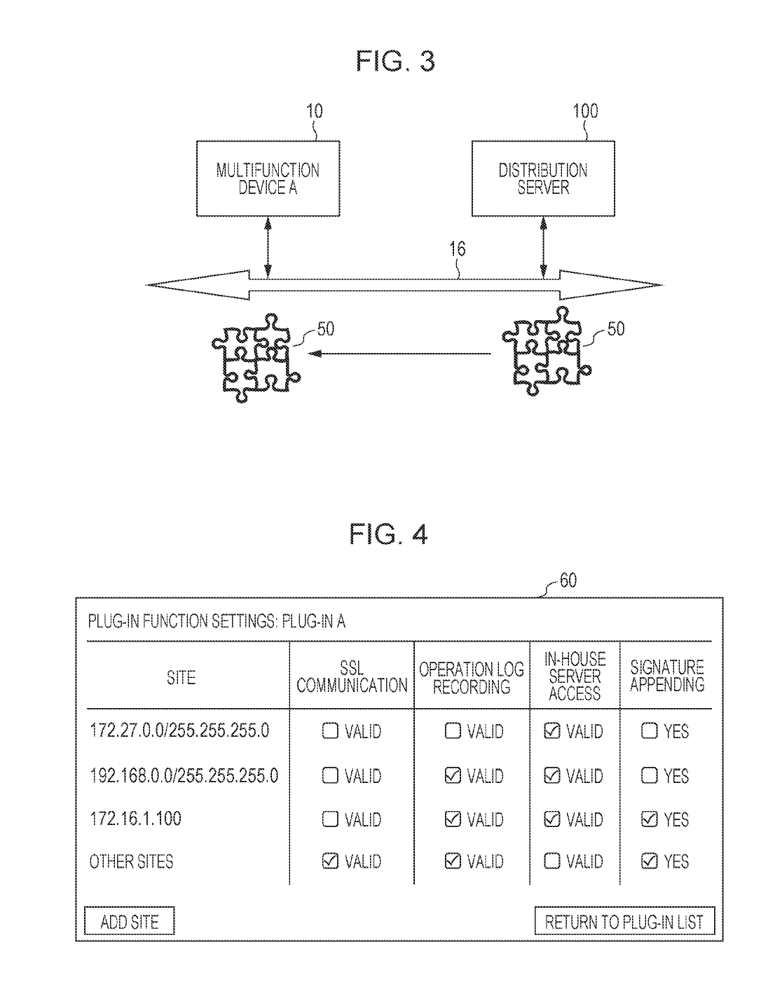

FIG. 3 schematically illustrates an operation for distributing a plug-in from the distribution server 100 to the multifunction device 10 in response to a request from the multifunction device 10.

Plug-ins 50 are stored in a memory of the distribution server 100, and upon receiving a plug-in request command from the CPU 24 of the multifunction device 10, a CPU of the distribution server 100 reads a requested plug-in 50 from the memory in response to the plug-in request command, and distributes the plug-in 50 to the multifunction device 10 via the network 16.

The CPU of the distribution server 100 sets functions for each plug-in, such as an address of a destination corresponding to the multifunction device 10 to which the plug-in will be distributed (distribution destination). Examples of the functions set for a plug-in are Secure Socket Layer (SSL) communication, operation log recording, an in-house server access, signature appending, etc. The CPU of the distribution server 100 individually sets these functions for each plug-in and then distributes a requested plug-in to the multifunction device 10. Functions set for a plug-in may be applied to all plug-ins or may be different according to the plug-in. For example, functions set for a certain plug-in may be SSL communication and operation log recording, and functions set for another plug-in may be Kerberos authentication and content encryption.

The distribution server 100 has different items of function setting information according to the plug-in or according to the distribution destination. Accordingly, functions to be set are different depending on the plug-in to be distributed, and even for the same plug-in, functions are different depending on the distribution destination. In FIG. 3, SSL communication for the plug-in 50 to be distributed to the multifunction device 10 may be set to be valid, while SSL communication for the plug-in 50 to be distributed to the multifunction device 12 may be set to be invalid. Additionally, SSL communication for the plug-in 50 to be distributed to the multifunction device 10 may be set to be valid, while SSL communication for another plug-in to be distributed to the multifunction device 10 may be set to be invalid.

FIG. 4 illustrates a list 60 of items of function setting information set for individual plug-ins stored in the distribution server 100 and set for individual distribution destinations. Function setting information may be added or updated if necessary by using a web application in the distribution server 100. Items of function setting information set for individual plug-in are stored in the memory of the distribution server 100.

In FIG. 4, among plural plug-ins, function setting information concerning a plug-in A is shown. Distribution destinations are indicated as “sites”, and for each distribution destination, the validity/invalidity of functions, that is, “SSL communication”, “operation log recording”, “in-house server access”, and “signature appending”, is set.

Concerning a distribution destination “172.27.0.0/255.255.255.0”, “SSL communication” is set to be invalid, “operation log recording” is set to be invalid, “in-house server access” is set to be valid, and “signature appending” is set to be invalid (not applicable). The term “in-house server access” means that access to an in-house server by using the plug-in A is permitted.

Concerning a distribution destination “192.168.0.0/255.255.255.0”, “SSL communication” is set to be invalid, “operation log recording” is set to be valid, “in-house server access” is set to be valid, and “signature appending” is set to be invalid (not applicable). The term “operation log recording” means that the date and time, for example, at the time of an operation of the plug-in A is recorded as a log.

Concerning a distribution destination “172.16.1.100”, “SSL communication” is set to be invalid, “operation log recording” is set to be valid, “in-house server access” is set to be valid, and “signature appending” is set to be valid (applicable). The term “signature appending” means that a digital signature is appended as protection against tampering of a plug-in itself. If a signature is appended, the integrity of the plug-in A can be verified by checking this signature.

Concerning other distribution destinations, “SSL communication” is set to be valid, “operation log recording” is set to be valid, “in-house server access” is set to be invalid, and “signature appending” is set to be valid (applicable). The reason why “SSL communication”, “operation log recording”, and “signature appending” are all set to be valid is that it is necessary to enhance the security of the plug-in A when distributing it to a destination in which it is unknown whether secure environments are provided. The reason why “in-house server access” is set to be invalid is that it is necessary to prevent a leakage of confidential information by prohibiting access to an in-house server.

In this manner, the validity/invalidity of functions for each plug-in and for each distribution destination is set in the function setting information. When distributing a plug-in, the functions of the plug-in are restricted in accordance with this function setting information. More specifically, in a default state, all the functions of each plug-in are set to be valid. Concerning a function which is set to be invalid, a class library which implements this function, for example, is deleted from the plug-in. For example, when distributing the plug-in A to the destination “172.27.0.0/255.255.255.0”, class libraries corresponding to “SSL communication”, “operation log recording”, and “signature appending” are deleted, and then, the plug-in A is distributed.

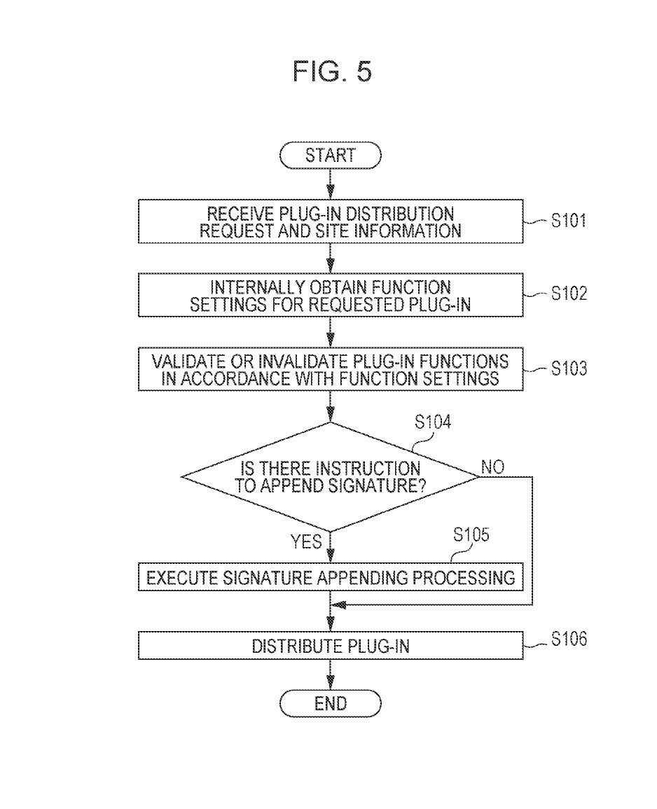

FIG. 5 is a flowchart of processing executed in this exemplary embodiment. This processing is executed by the distribution server 100 in response to a plug-in distribution request.

In step S101, the CPU of the distribution server 100 receives a plug-in distribution request and destination information (site information) from the multifunction device 10 or another multifunction device. If the IP address of the multifunction device 10 is “172.27.0.0” and the plug-in A has been requested, the CPU of the distribution server 100 receives this IP address and a request command for the plug-in A.

Then, in step S102, the CPU of the distribution server 100 internally obtains function settings for the requested plug-in. Items of function setting information concerning individual plug-ins are stored in the memory of the distribution server 100, and thus, the CPU of the distribution server 100 reads function setting information set for the requested plug-in from the memory. If the requested plug-in is the plug-in A, the CPU of the distribution server 100 searches for function setting information set for the plug-in A and reads it from the memory.

Then, in step S103, the CPU of the distribution server 100 validates or invalidates the functions set for the requested plug-in by utilizing the obtained function setting information. Items of function setting information are set for individual distribution destinations (sites), as shown in FIG. 4, and thus, the CPU of the distribution server 100 validates or invalidates the functions set for the requested plug-in in accordance with the distribution destination. If the plug-in A has been requested from the multifunction device 10, the CPU of the distribution server 100 validates “in-house server access” and invalidates “SSL communication”, “operation log recording”, and “signature appending” on the basis of the IP address of the multifunction device 10. Thus, the CPU of the distribution server 100 deletes class libraries of “SSL communication”, “operation log recording”, and “signature appending” from the plug-in A and thereby invalidates these functions. If the plug-in A has been requested from the multifunction device 12 and the IP address of the multifunction device 12 is one of “other sites” shown in FIG. 4, the CPU of the distribution server 100 invalidates only “in-house server access” even if the same plug-in A will be distributed.

After validating or invalidating the functions of the plug-in A, the CPU of the distribution server 100 proceeds to step S104 and checks whether or not an instruction to append a signature for the requested plug-in has been validated. If the instruction has been validated, the CPU of the distribution server 100 proceeds to step S105 and executes signature appending processing by using a known digital signature appending method. After appending a digital signature, in step S106, the CPU of the distribution server 100 distributes the plug-in to the multifunction device which has requested the plug-in.

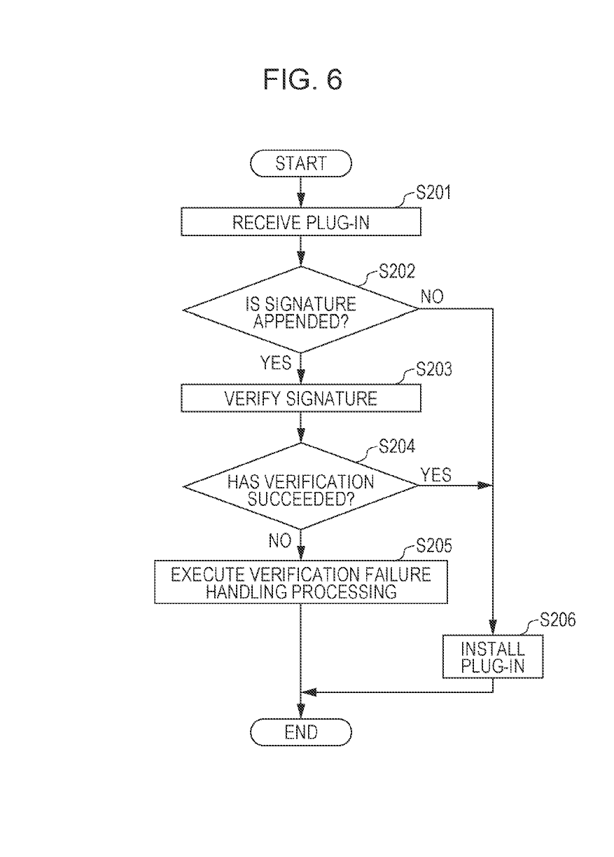

FIG. 6 is a flowchart of processing executed in this exemplary embodiment. This processing is processing executed by a multifunction device when downloading a plug-in distributed from the distribution server 100. In the following example, it is assumed that the multifunction device 10 downloads a plug-in.

In response to an instruction to download a plug-in given from a user by performing an operation on the operation panel 22, the CPU 24 of the multifunction device 10 conducts predetermined authentication with the distribution server 100, and then, sends a request to distribute a desired plug-in and the IP address of the multifunction device 10 as the destination information. Then, in step S201, the CPU 24 of the multifunction device 10 receives a plug-in distributed from the distribution server 100. In this plug-in, functions are already set by the distribution server 100 on the basis of function setting information. Then, in step S202, the CPU 24 of the multifunction device 10 determines whether or not a signature (digital signature) is appended to the plug-in.

If the signature is appended, the CPU 24 of the multifunction device 10 proceeds to step S203 and verifies the signature by using a known method. Then, the CPU 24 of the multifunction device 10 determines in step S204 whether or not the signature has been successfully verified. If the signature has been successfully verified, the integrity of the received plug-in is guaranteed. Accordingly, the CPU 24 of the multifunction device 10 proceeds to step S206 and stores the plug-in in the storage device 28 and installs it. If it is determined in step S202 that there is no signature appended to the plug-in, the CPU 24 of the multifunction device 10 immediately stores the plug-in in the storage device 28 and installs it without performing the verification of a signature.

In contrast, if it is determined in step S204 that the signature has not been successfully verified, the CPU 24 of the multifunction device 10 proceeds to step S205 and executes predetermined processing to handle a signature verification failure, for example, displaying an error message on the operation panel 22 or requesting the redistribution of a plug-in. In this case, the received plug-in is not installed, and the use of the plug-in is not permitted.

After downloading the plug-in provided with function settings, on the operation panel 22, the CPU 24 may display information that the plug-in has been downloaded, and may also display a list of validated functions and invalidated functions so as to call a user's attention. For example, if access to an in-house server using the downloaded plug-in is invalidated, a message, for example, “access to an in-house server is not permitted”, may be displayed on the operation panel 22. In short, it is desirable that information is displayed so as to allow a user to recognize functions which have been set on the basis of function setting information. In response to a request from a user, the reason why a certain function for a plug-in has been set may be displayed. That is, since function setting information is set for each plug-in and for each distribution destination, it is possible to inform the user of whether a certain function of a downloaded plug-in is restricted for all the devices or only for the multifunction device 10. The CPU 24 may determine for each user whether or not the reason for setting a function will be displayed.

As described above, in this exemplary embodiment, in a distribution server which distributes plug-ins, function setting information provided for each plug-in and for each distribution is stored, and the distribution server validates or invalidates functions set for a plug-in to be distributed on the basis of this function setting information. Accordingly, it is possible to impose restrictions on the use of the functions of a plug-in in a flexible manner depending on the security environments of a distribution destination, thereby making it possible to implement the appropriate use of plug-ins.

The function setting information is stored in the memory of the distribution server 100. However, administrators administrating the multifunction devices 10, 12, and 14 create items of function setting information by using personal computers (PCs) of the associated multifunction devices and store the created items of function setting information in the memory of the distribution server 100 via a network, such as the Internet.

The present invention has been discussed through the above-described exemplary embodiment. However, the present invention is not restricted to this exemplary embodiment, and various modifications may be made.

For example, in FIG. 4, items of function setting information set for individual plug-ins and for individual distribution destinations are stored. In this case, in addition to the functions shown in FIG. 4 or instead of the IP address of a distribution destination, the user ID of a distribution destination may be used.

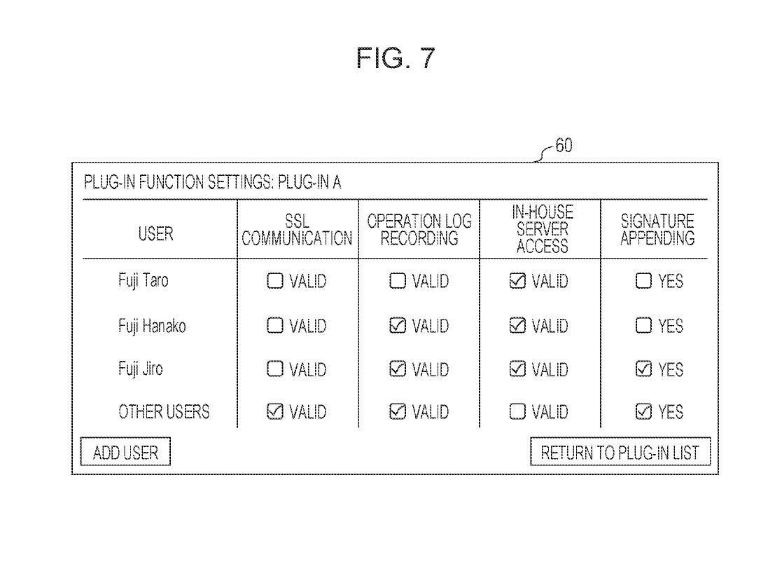

FIG. 7 illustrates a list of items of function setting information when the user ID is used instead of the IP address. The list shown in FIG. 7 is different from that shown in FIG. 4 in that function setting information is set for each user ID (user name) instead of each site. When the multifunction device 10 sends a plug-in request to the distribution server 100, it sends the user ID together with the IP address. Since a user utilizing the multifunction device 10 conducts user authentication by inputting a user ID and a password, the user sends this user ID to the distribution server 10. The CPU of the distribution server 100 checks function setting information set for the received user ID, and validates or invalidates the functions of the requested plug-in.

In this exemplary embodiment, as examples of the functions set for plug-ins, SSL communication, operation log recording, in-house server access, digital signature appending, Kerberos authentication, and content encryption have been discussed. These functions may be combined appropriately. For example, the validation/invalidation of only “SSL communication” is set for a plug-in A, the validation/invalidation of only “digital signature” is set for a plug-in B, and the validation/invalidation of “SSL communication” and the validation/invalidation of “Kerberos authentication” are set for a plug-in C. In short, the functions for a plug-in to be set by utilizing function setting information may be at least one of SSL communication, operation log recording, in-house server access, digital signature appending, Kerberos authentication, and content encryption.

Additionally, the function for a plug-in are not restricted to the above-described functions, and may be a function of restricting the use of a plug-in itself. More specifically, the number of usage times of a plug-in may be set for each plug-in and for each distribution destination. For example, concerning the plug-in A, the number of usage times for a certain destination may be one, and the number of usage times for another destination may be ten, and the number of usage times for still another destination may be unlimited. Then, concerning the plug-in B, the number of usage times for a certain destination may be ten, and the number of usage times for other destinations may be unlimited. Upon receiving a plug-in for which functions are set in this manner, a distribution destination checks the number of usage times appended to the plug-in, and if the plug-in may still be used, the distribution destination stores and installs the plug-in in the storage device 28 and utilizes it. Every time the plug-in is installed or utilized, the CPU 24 decrements the number of usage times, and when the number of usage times has reached 0 (if there is a restriction on the number of usage times), the CPU 24 prohibits the use of the plug-in. If the user ID is used instead of the distribution destination, the number of usage times may be set for each user ID. If the user ID is used in addition to the distribution destination, the number of usage times may be set for each of plural user IDs of the same distribution destination. For example, concerning the plug-in A, the number of usage times for a certain user ID of a certain distribution destination may be one, and the number of usage times for another user ID of the same distribution destination may be ten. In this manner, by setting functions in details for each plug-in, for each distribution destination, and for each user ID, plug-ins may be distributed in various manners that match a variety of different security environments.

Plug-in function setting information may be set, not only according to the plug-in, the distribution destination, and the user ID, but also according to the time zone or the season. For example, concerning the plug-in A, a certain destination may use the plug-in A only in the morning, and another destination may use the plug-in A only in the afternoon.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A plug-in distribution system comprising:
a distribution server that distributes a plug-in; and
an image processing apparatus that is connected to the distribution server via a network and that receives a plug-in from the distribution server and uses the received plug-in,
wherein, in response to a request to distribute a plug-in from the image processing apparatus, the distribution server sets a function for the requested plug-in in accordance with function setting information which is set for each plug-in and for each distribution destination, and distributes the plug-in to the image processing apparatus.

2. The plug-in distribution system according to claim 1, wherein the function setting information is information for setting whether or not at least one of functions of SSL communication, operation log recording, access to a specific server, digital signature appending, predetermined authentication, and content encryption is valid for a plug-in.

3. An image processing apparatus comprising:
a requesting unit that sends a request to distribute a plug-in to a distribution server;
a receiver that receives the plug-in distributed from the distribution server in response to the request, a function for the plug-in being set in accordance with function setting information which is set for each plug-in and for each distribution destination; and
a memory that stores therein the plug-in received by the receiver.

4. The image processing apparatus according to claim 3, wherein the function setting information is information for setting whether or not at least one of functions of SSL communication, operation log recording, access to a specific server, digital signature appending, predetermined authentication, and content encryption is valid for a plug-in.

5. The image processing apparatus according to claim 3, further comprising:
a verifying unit that verifies a digital signature appended to the plug-in received by the receiver if a function of digital signature appending for the plug-in is valid.

6. A plug-in distribution control method comprising:
sending a request to distribute a plug-in from an image processing apparatus to a distribution server;
sending information concerning a distribution destination from the image processing apparatus to the distribution server;
receiving the request and the information concerning the distribution destination by the distribution server, setting, by the distribution server, a function for the requested plug-in in accordance with function setting information which is set for each plug-in and for each distribution destination, and distributing the plug-in from the distribution server to the image processing apparatus; and
receiving the plug-in and storing the plug-in in a memory by the image processing apparatus.
